(19) United States
(12) Patent Application Publication
(10) Pub. No.: US 2024/0342677 A1
(43) Pub. Date: Oct. 17, 2024

(54) RADIOCHEMICAL WORK STATION

(71) Applicant: Accuro Therapeutics, LLC, Philadelphia, PA (US)

(72) Inventor: Youwen Xu, Philadelphia, PA (US)

(73) Assignee: Accuro Therapeutics, LLC, Philadelphia, PA (US)

(21) Appl. No.: 18/634,413

(22) Filed: Apr. 12, 2024

Related U.S. Application Data
(60) Provisional application No. 63/458,780, filed on Apr. 12, 2023.

(51) Int. Cl. B01J 19/00; B25J 9/00

(52) U.S. Cl. CPC B01J 19/00; B25J 9/00

(57) ABSTRACT

An automated radiochemical reaction system includes a compact 6DOF intelligent robot, a chemical reaction unit and the other hot cell interior elements. They are assembled within a space restrained hot cell where chemical reaction or chemical reaction like actions autonomously are performed. The attached end effector at the end of the robot arm is adapted to grasp, release, and actuate components within the hot cell, as required to automatically and autonomously perform the radiochemical research and development without human interaction.

### FIELD OF INVENTION

The present disclosure is directed to a chemical working station, and more particularly it is directed to an automated robotic radiochemical working station.

### BACKGROUND

Fast-advancing robotic technology is providing the possibility for higher levels productivity and safer working conditions in the medical/biomedical manufacturing industry and research laboratories. As such, automated chemistry, online analysis, and real-time optimization can now be autonomously carried out by a robot. Nuclear medicine research and radiopharmaceutical development is a particular sector which needs an innovative transformation to improve productivity, lower the costs, and provide safer working conditions for the researchers. More specifically, the closely observed safety regulations regarding shielding, distance, and personnel exposure time to radioactive materials/chemicals severely hinders the productivity of the research process. Further, the demand for well-trained experts and skilled professionals for carrying out the radiochemistry reaction, and the demand for safer and faster radioactive material handling is constantly challenged.

As such, there is a need for a solution that increases productivity, reduces costs, and provides safer working conditions in the nuclear medicine research and radiopharmaceutical development sectors of the medical and/or biomedical manufacturing industry and research laboratories.

### SUMMARY

According to one aspect, the present disclosure is directed to an automated radiochemical reaction system that includes a compact 6DOF intelligent robot, a chemical reaction unit and other interior elements equipped within a hot cell. They are assembled within a space restrained hot cell for a chemical reaction or a chemical reaction like actions autonomously are performed. The attached end effector at the end of the robot arm is adapted to grasp, release, and actuate components within the hot cell, as required to automatically and autonomously perform the radiochemical research and development without human interaction.

### BRIEF DESCRIPTION OF THE DRAWINGS

The foregoing Summary as well as the following Detailed Description will be best understood when read in conjunction with the appended drawings, which illustrate a preferred embodiment of the disclosure. In the drawings:

FIG. 1 is a perspective view of a hot cell (i.e., a typical lead shielded nuclear radiation containment chamber) of the present disclosure.

FIG. 2 is a perspective view of the chemical reaction unit.

FIG. 3 includes a perspective interior view and a top view of the hot cell floor of the present disclosure.

FIG. 4 is a perspective view of the hot cell equipped with the robot, the chemical reaction unit and other elements on the wall of the present disclosure.

FIG. 5 includes several views of a 6DOF robot adopted of the present disclosure. (PeterCorke.com, 2020)

FIG. 6 includes views of an end effector of the robot for medical syringe manipulation.

FIG. 7 includes several views of typical consumable supplies in which the end effector of the robot can interact with during the research and handling process.

FIG. 8 is a diagram illustrating a general radiochemical reaction process used for the robot motion program of the present disclosure.

### DETAILED DESCRIPTION OF THE PREFERRED EMBODIMENT(S)

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft or any other cylindrical member. A reference to a list of items that are cited as “at least one of a, b, or c” (where a, b, and c represent the items being listed) means any single one of the items a, b, or c, or combinations thereof are included. The terms “about” and “approximately” encompass+/−10% of an indicated value unless otherwise noted. The terminology includes the words specifically noted above, derivatives thereof and words of similar import.

Previous approaches have attempted to automate the radiochemical reaction process that are suitable for research development and manufacturing. However, most of the research development are still performed manually due to the costs and availability of the instrument. Specifically, current market available automated radiochemistry reaction instruments are designed either reaction type oriented or fixed special supply part oriented. In the reaction type oriented approach, one machine is designed and configured to run only one type of reaction at a time, which decreases productivity. In the fixed special supply part oriented approach, special or unique supplies are required, which increases costs and has supply chain risk. Often the machines in the hot cells are used only once per day due to unsafe radiation levels for the workers. Then the machines are used again only after the radiation level has decayed to a safe level for workers to open the hot cell to perform the cleaning and next experiment setup.

In addition, in previous approaches large numbers of solenoid valves and other mechanical components are required in order to transfer the chemical liquid and/or gas from one reactor to the other. This increases the difficulty in maintenance among other issues. New solution for automating the radiochemical reactions and suitable for fast pace daily research and developmental use is desired. And, the increased productivity, reduced costs, safer working environment, and relieved supply chain restrictions are the benefits expected to come with.

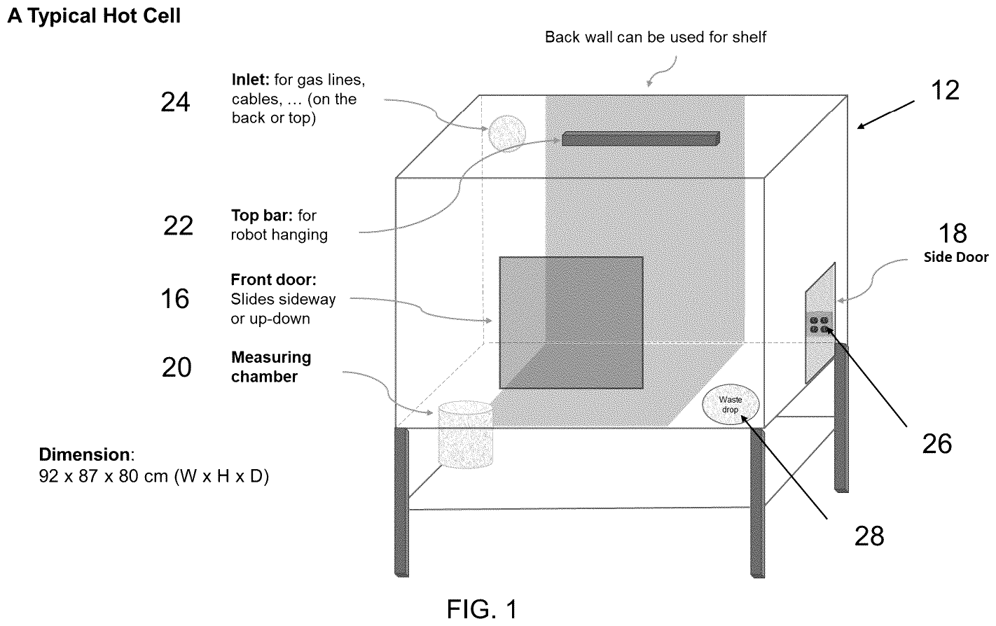

FIG. 1 is a perspective view of a typical lead shielded hot cell 12 of the present disclosure. Hot cell 12 protects workers from the radiation exposure when radioactive material is being used in the hot cell. As illustrated, the volume of the hot cell 12 is relatively small, and in some embodiments the hot cell 12 can have a volume of less than 1 cubic meter. have a width of approximately 92 cm, a height of approximately 87 cm, and a depth of approximately 80 cm.

A compact 6DOF intelligent robot, a chemical reaction unit and other interior elements are assembled within the hot cell to form the automated radiochemical reaction system 10.

A compact intelligent 6DOF robot 14, a chemical reaction unit and other interior elements are installed inside this confined hot cell space (<1 m³) to perform chemical reaction or chemical reaction like actions autonomously, discussed further below. Due to the space restriction, a robot typically used in the open space of a biological laboratory doesn't fit the purpose of this disclosure as collision with the wall and/or objects with in the hot cell may occur. To remedy the aforementioned issue, the compact intelligent robot 14 of the present application is appropriately sized and configured such that the kinetics and dynamics of the robot 14 movement will be well directed by a set of algorithms that is suited to the physical restrictions imposed within the hot cell 12. Assuming the servos are all at their mid-range or 180-degree positions (which corresponds to the zero joint angle configuration), the kinematics can be expressed using the Elementary Transform Sequence (ETS) as follows with the base located at the intersection of joint 1 and the hot cell ceiling contact point, and the end-effector is positioned at the midpoint of the base of the fingers. The elbow offset is restrained for the purpose of keeping the object held by the end effector always upright ward. [Peter Corke, 2020]

$$Rz ( q 1 ) Tz ( L 1 ) Ry ( q 2 ) Tz ( L 2 ) Tx ( L 3 ) Ry ( q 3 ) Tx ( L 4 ) Rx ( q 4 ) Tx ( L 5 ) Ry ( q 5 ) Tx ( L 6 ) Rx ( q 6 ) Tx ( L 7 ) \qquad Equation 1$$

At a high level, the hot cell 12 illustrated in FIG. 1 includes a front door 16, a side door 18, measuring chamber 20, a top bar 22, an inlet 24, an electrical outlet 26, and a waste drop 28. Each of the different features/components of the hot cell 12 are included to aid in the automated radiochemical research and development process. The front door 16 can be opened and closed to access the interior of the hot cell 12. The front door 16 can be opened to allow a researcher (human) to add or remove components to/from the hot cell 12 before or after the chemical reaction. Further, the front door 16 can be closed during the chemical reaction process.

The measuring chamber 20 can be used to measure the quantity or amount of radioactive material in a sample vial. within the hot cell 12. The top bar 22 is connected with the frame of the chemical reaction unit and to be used to hang the robot 14 upside down (not shown) within the hot cell 12. In other embodiments the top bar 22 could be coupled to any other side wall within the hot cell 12. Further, in other embodiments, the top bar 22 can be coupled to the ceiling of the hot cell 12. As such, the robot 14 can be coupled to the top bar 22 and the robot 14 can be coupled to any side wall or the ceiling of the hot cell 12.

The inlet 24 of the hot cell 12 can be an opening or passage that allows gas lines, cables, power cords, etc. to be passed through the side wall into the interior of the hot cell 12. The lines, cables, cords, tubes, etc. that are passed through the inlet 24 and into the interior of the hot cell 12 can each be utilized to aid in the radiochemistry research and development process. The electrical outlet 26 can be coupled to a side wall (or the ceiling or the floor/base) of the hot cell 12. As is readily understood, the robot 14 can be electrically coupled to the electrical outlet 26 to receive electrical energy to power and energize the robot 14. The waste drop 28 is beneath the hot cell floor with an opening allowing the used supplies to be dispensed within while the chemical reaction and/or experiment in process. Although the waste drop 28 is shown extending within and through the floor/base of the hot cell 12, it is to be understood that the waste drop can also be a waste container positioned inside the hot cell 12.

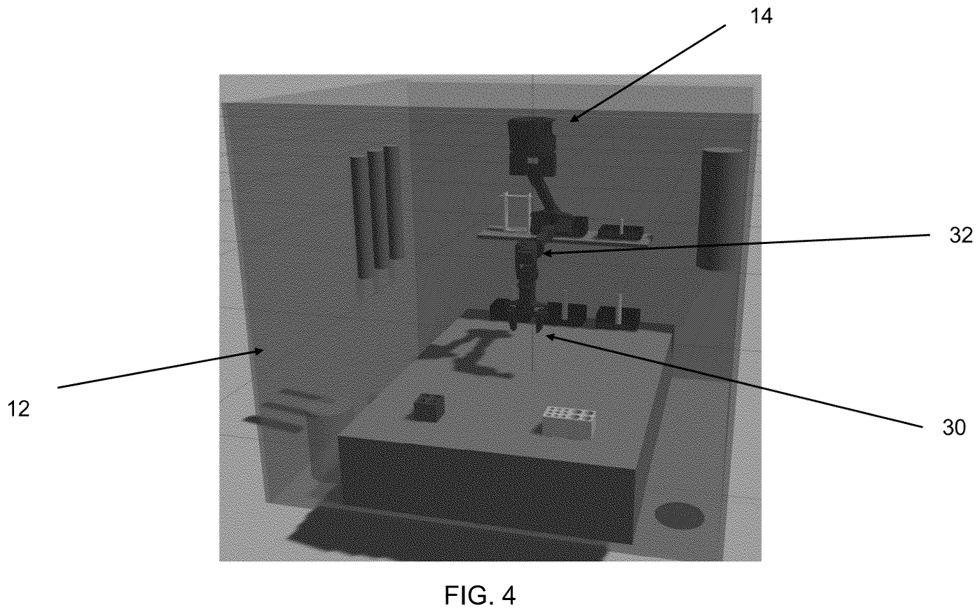

In operation, a robot 14 (shown in FIG. 4) is coupled within the hot cell 12 and the robot 14 is configured to move within the hot cell 12 to perform all the requisite movements and operations to perform the desired chemical reaction and/or experiment while preventing collision with the walls and any other components within the hot cell 12, discussed further below.

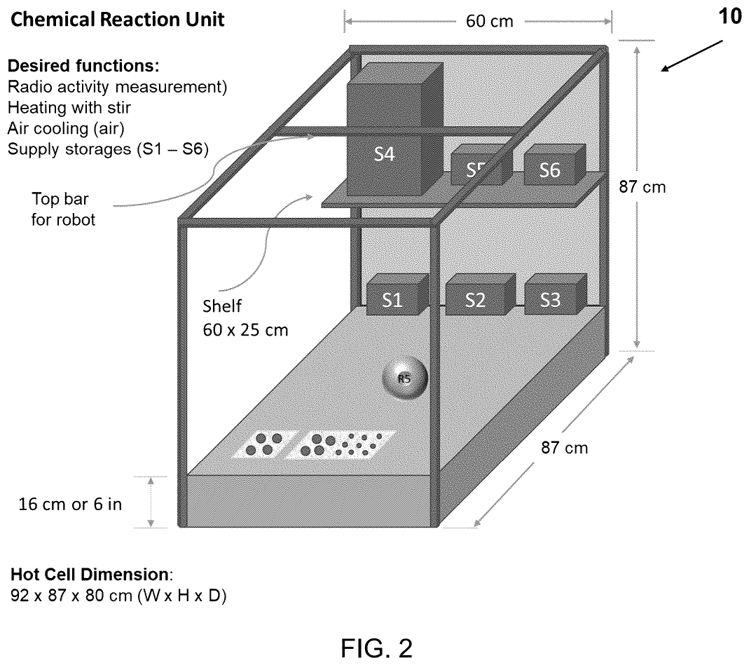

FIG. 2 is a perspective view of the chemical synthesis unit possesses essential function of heating (up to 200° C.), cooling (compressed air cool to room temperature), magnetic stirring (two), radiation detecting (five detectors), chemical components analysis and processing for purification, HPLC (High-performance liquid chromatography) sample stations and the reagent and consumable supply storages etc. etc.

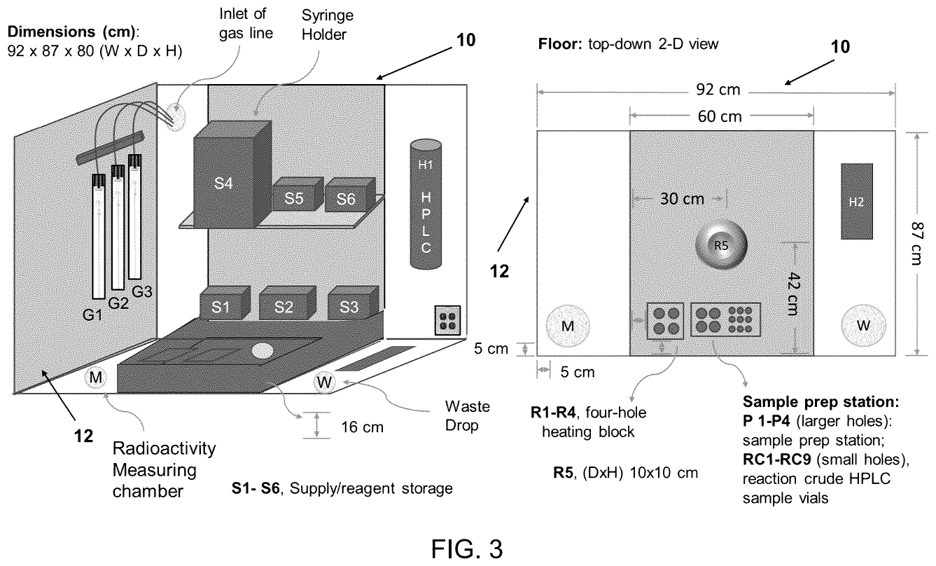

FIG. 3 includes various views of the hot cell 12 including many different components that are used to perform the desired chemical reaction and/or experiment. As illustrated, the hot cells 12 illustrated in FIG. 3 include many of the same components as the hot cell 12 discussed in FIG. 1, the chemical reaction unit discussed in FIG. 2, the robot discussed in FIG. 4, and the discussion regarding those components equally applies to FIG. 3. In addition, the hot cells 12 can include a, HPLC column attached to the back wall, a HPLC UV detector is placed on the hot cell floor near the HPLC columns. And the UV-vis spectrometer is included in the system. Each of the listed components are utilized to aid in the chemical reaction experiment, and each will not be discussed in detail as they are known in the traditional chemical reaction experimental process. With that said, the specific shape, size, and positioning of each of the listed components is strategically chosen such that the robot 14 can interact with each listed component precisely without colliding within or otherwise inadvertently contacting other components within the hot cell 12.

In other words, each of the chemicals/components must be strategically sized and positioned within the hot cell 12 such that an end effector of the robot 14 can interact with each of the components to complete the chemical reaction. Further, each of the components must be strategically sized and positioned within the hot cell 12 such that the robot (end effector or robot arm) does not inadvertently contact a component and cause a spill or otherwise detrimentally affect the chemical reaction and/or experiment. To achieve the aforementioned, components within the hot cell 12 are distributed about the hot cell 12. More specifically, the chemicals/components (i.e., chemical vials, syringes, and other testing equipment) can be positioned within containers that are coupled to the side walls, the ceiling, and/or the floor/base or the hot cell 12, allowing the robot 14 to reach and access each of the components within the hot cell 12 while preventing inadvertent contact with the chemicals/components within the hot cell 12.

FIG. 4 is a 3-dimensional illustration of an example hot cell 12 with a robot 14 coupled to the ceiling of the hot cell 12, and the chemical reaction unit positioned in the middle of the hot cell. As discussed, the robot 14 is configured to reach and access each of the chemicals/components within the hot cell 12 while preventing inadvertent contact with the chemicals/components within the hot cell 12. An example of one specific operation that can be completed by the robot 14 includes the following. The robot 14 can move an end effector 30 of the robot 14 to a syringe within a storage container coupled to the back chemical reaction system 10. Next, the end effector 30 can grab onto and lift a syringe from the storage container. Then, the end effector 30 can move the syringe filled with a chemical to a vial on the sample station within the hot cell 12. Then the end effector 30 can dispense the syringe content into the sample vial. Lastly, the robot 14 can move the used syringe to the waste drop and the end effector can release the syringe to drop the syringe into the waste drop for disposal. The robot 14 can then continue by performing many other movements and operations to complete the chemical reaction and/or the experiment.

Although not illustrated, it is to be understood that the robot 14 is communicatively coupled to a computer or controller that automatically and/or autonomously controls the movement and operations of the robot 14. The controller can include a predefined “environment” of the interior of the hot cell 12, such that the location and the size or the shape of the components can be known by the controller. As such, the controller can include algorithms or instructions that can be sent to the robot 14 to control each and every movement of the robot 14 to prevent inadvertent collisions within the hot cell 12. The inadvertent collision during the chemical reaction experiment can also be avoided with the assistance of a plurality of sensors and/or even cameras (vision systems)

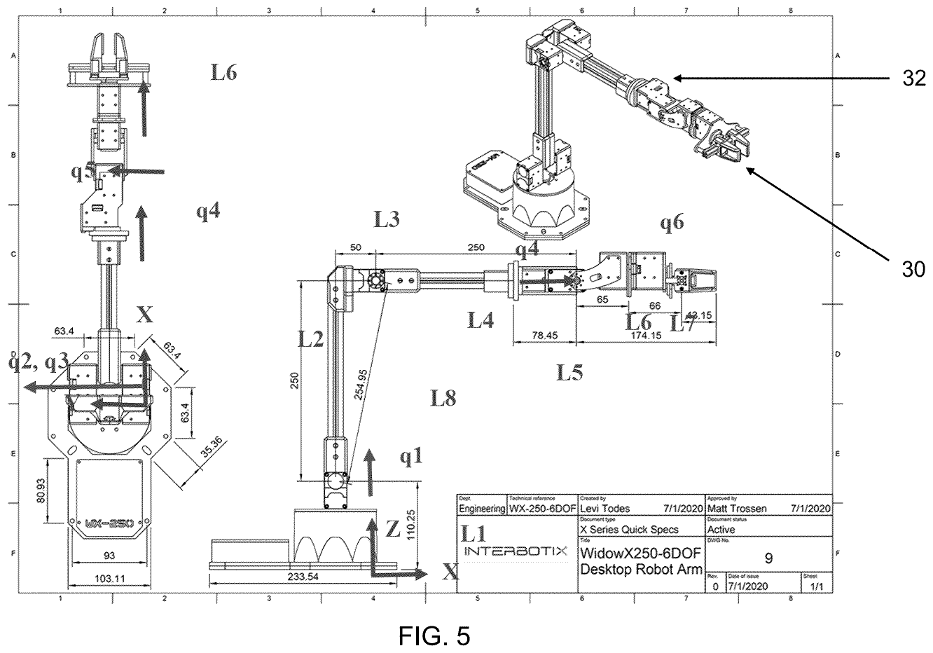

FIG. 5 includes several views of an example robot 14 that can be used within the hot cell 12. As illustrated the robot 14 can include an end effector 30 coupled to the robot arm 32. The robot arm 32 aids in properly positioning the end effector 30 within the hot cell 12, and the end effector 30 is utilized to grab and release various components within the hot cell 12, discussed further below. As illustrated, the robot 14 can include multiple degrees of freedom, allowing the robot 14 to reach every corner of the hot cell 12. In addition, sets of robot motion restriction are imposed for the purpose of maintaining the subject full of liquid chemicals held by the robot always in an upright configuration. The high degree of freedom of this 6DOF robot joints secured robot joint flexibility needed for the task completion. As such, this ensures that the contents of the vial are not spilled within the hot cell 12. Further, although not illustrated, it is to be understood that the robot 14, controller, and/or the hot cell 12 can include a graphical user interface (GUI) that allows the user to interact with, view statistics and other information, and control the movement of the robot 14 and the overall chemical reaction experiment.

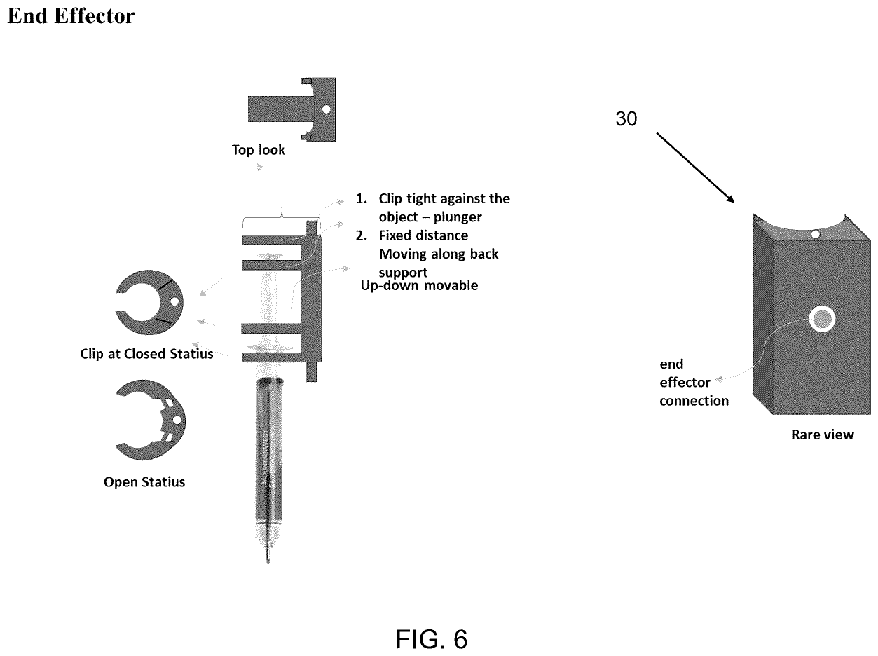

FIG. 6 includes various views of an example end effector 30 that can be utilized to securely hold a syringe 34. Further, the end effector 30 can also be utilized to actuate the syringe 34 to draw or pull fluid into the syringe 34, and then actuate the syringe 34 to dispense or expel the fluid out of the syringe 34.

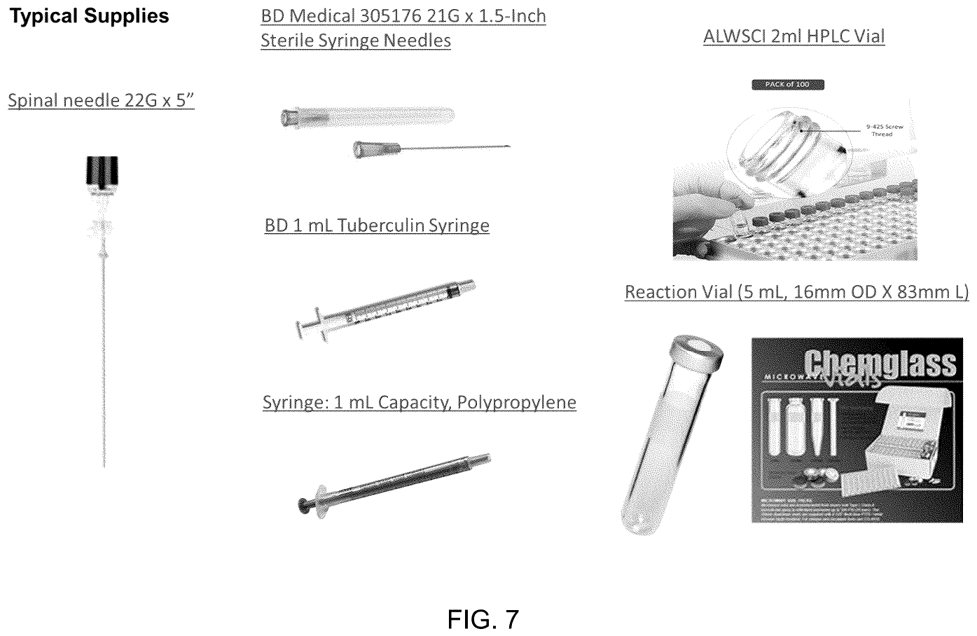

FIG. 7 includes various views of components that are utilized in the radiochemistry research and development process. Further, FIG. 7 includes various views of components that can be grabbed, released, and actuated by the end effector 30. In some examples, the end effector 30 can engage and interact with spinal needles, sterile syringe needles, a tuberculin syringe, a polypropylene syringe, HPLC vials, and reaction vials, among other components and objects not specifically listed.

Referring again to FIG. 6, the end effector 30 can include an actuatable and extendable body 40, a first grip 42, a second grip 44, a third grip 46, and a fourth grip 48. Further, in some examples (as illustrated), the body 40 can have a generally C-shaped cross-section viewing from the top down along an axial direction of the body 40. As illustrated, the body 40 can be actuatable in the radial direction (with respect to the central axis of the C-shaped body 40), such that the body 40 can be described as a clasp or clip. More specifically, the body 40 can be actuated to open and extend the body 40 in the radial direction. Then the opened body 40 can be inserted onto a syringe 34, and the body 40 can be actuated to close the body 40 in the radial direction such that the body 40 of the end effector 30 clasps/clips onto the syringe 34. In other words, the body 40 can be opened, positioned on the syringe 34, and then closed to couple the end effector 30 to the syringe 34. Although not illustrated, it is to be understood that the end effector 30 can includes at least one spring or elastic element that biases the end effector 30 into a closed position. As such, the robot 14 can cause the end effector 30 to open and then the spring or elastic member can cause the end effector 30 to close. In addition, as illustrated, the body 40 of the end effector 30 can include a ribbed surface extending axially through the body, such that the ribbed surface can aid in securing the syringe 34 to the body 40 of the end effector 30.

In addition, the first grip 42 and the second grip 44 can be positioned on opposite sides of a plunger grip 36 of the syringe 34, securing the plunger grip 36 between the first grip 42 and the second grip 44 of the end effector 30. Likewise, the third grip 46 and the fourth grip 48 can be positioned on opposite sides of a base grip 38 of the syringe 34, securing the base grip 38 between the third grip 46 and the fourth grip 48. Once the syringe 34 is fully coupled to the end effector 30 (through the body 40 and grips 42, 44, 46, 48), the body 40 can be extended axially along the central axis of the end effector 30 to cause the plunger grip 36 to translate away from the base grip 38. In turn, the aforementioned translation causes the syringe 34 to draw or pull liquid into the syringe 34. The opposite steps can be taken to dispense the liquid within the syringe 34 out of the syringe 34 into a vial or any other component.

The end effector 30 can include an opening or coupling point on a rear or back surface of the end effector 30. The opening or coupling point is the location in which the end effector 30 can be coupled to the robot arm 14. As such, the robot 14 can control and operate the end effector 30 to grab, release, translate (draw and dispense), etc. to perform various movements and operations to facilitate the radiochemical reaction process/experiment. More specifically, the end effector 30 allows the robot 14 to interact with syringes, vials, etc. to automatically and/or autonomously conduct radiochemical research and development without human interaction. Although the end effector 30 is described as having a generally C-shape, it is to be understood that the end effector 30 can have any other shape as long as the end effector 30 can interact with (grab, release, draw/dispense) with syringes, vials, and other components to complete the desired experiment and/or research process.

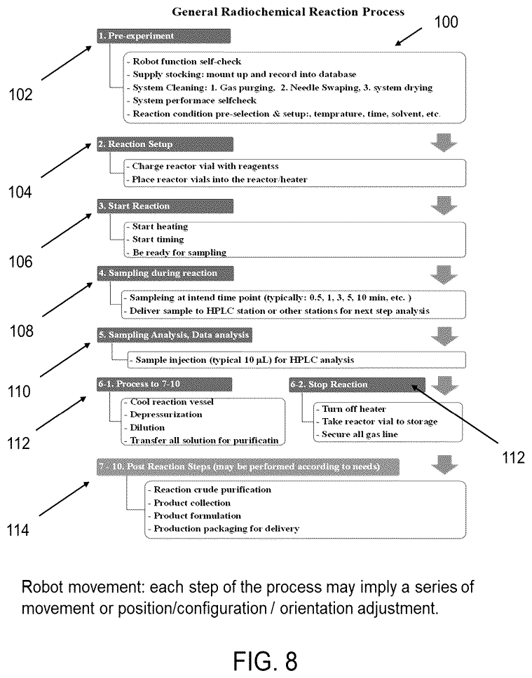

FIG. 8 is a diagram illustrating the Method 100 for the robot motion planning by following a general radiochemical reaction process. Method 100 includes steps 102-116, each of which will be discussed in detail below. Further, it is to be understood that each step in the Method 100 implies a series of movements or position/configuration adjustments of the robot 14 to complete the method 100.

Step 102 is the pre-experiment step in which the robot 14 performs a function (i.e., health/performance) check for the whole chemical reaction system that includes the robot itself, the chemical reaction unit, other components coupled within the hot cell 10. the radiochemical experiment supplies are supplied to the hot cell 12 and the inventory is recorded into a database of the controller. Step 102 further includes a system self-cleaning in which the hot cell 12 is purged of gas, the needles are swapped, and the system is dried. Next, at step 102, the overall system performs a self-check and the reaction conditions are selected and setup (e.g. temperature, time, solvent, etc.).

Step 104 is the reaction setup step in which the reactor vial is charged with reagents, and then the reactor vials are placed into the reactor/heater.

Step 106 is the start reaction step in which the heater and timer are started, and the robot 14 is ready to take a sample. Step 108 is the sampling during reaction step in which samples are taken from the heated vial at specific time internals (e.g., 0.5, 1, 3, 5, 10 min, etc.), and then the samples are delivered to the HPLC station or other station for analysis. Step 110 is the sample and data analysis step in which a specified amount (e.g., 10 micro liters) of the sample is drawn fro the reaction vessel is subject for the HPLC analysis or the UV-vis spectroscopy analysis. Step 112 is the process and stop reaction step, in which the reaction vessel is cooled, the reaction vessel is depressurized, and then all solutions are transferred for purification. Further, step 112 includes turning off the heater, transferring the reactor vial to storage, and then securing all the gas lines. Step 114 is the post reaction step that can be performed according to the needs of the experiments. Step 114 can include reaction crude purification, product collection, product formulation, and production packaging for delivery.

Method 100 is an overview of the general radiochemical reaction process that can be automatically and/or autonomously performed by the robot 14. It is to be understood that method 100 can include fewer than or more than the listed steps, as is needed for the specific radiochemical research and development process. As discussed, each of the listed steps can be automatically and/or autonomously performed by the robot 14 within the hot cell 12. Further, each of the steps 102-114 indicate movement, position/configuration adjustment, and/or actuation of the end effector 30 to complete the listed step. As such, it is to be understood the overall system including the hot cell 12 and the robot 14 can automatically and/or autonomously perform method 100 without human interaction and intervention. Specifically, the controller of the system includes the software/code that allows the robot 14 to perform each of the listed steps and to problem solve in the event that an issue occurs during the reaction process.

In addition, it is to be understood that the robot 14 can perform each of the following maneuvers based on instructions received from the controller, the robot: 1) moves to the starting position; 2) picks up a first vial; 3) places the first vial; 4) picks up a second vial; 5) places the second vial; 6) picks up a syringe; 7) extracts a liquid from the second vial using the syringe; 8) injects the extracted liquid into the first vial using the syringe; 9) disposes of the syringe; 10) picks up the first vial and shakes the first vial to mix the contents; 11) places the shaken first vial; 12) disposes of the second vial; 12) picks up the first vial; 13) places the first vial in the heater. As such, based on the above, it is to be understood that the robot automatically and/or autonomously performs each of the aforementioned steps without human intervention. Therefore, the robot 14 of the present invention is design to carry out an entire radiochemical reaction process without human intervention.

As will be appreciated by those skilled in the art, the disclosed hot cell 12 is designed for high throughput quick step-by-step radiochemistry reaction condition assessment of target compounds in a confined radiochemistry space. The featured maneuver/mobile robotics carries out the work that is traditionally done by human hands. The results, analysis, and decision making are based on the collected testing data. The robot 14 is able to maintain itself in a continuous working mode until the task is completed, and in a situation of a common mechanical or electronic failure, the robot 14 should be capable of performing certain problem diagnostic, minor problem solving, and resume action function. Further, existing end-effectors cannot satisfy the need for picking up the small and fragile parts (such as glass vials and syringes) due to limited space, and it is also not suitable for a dual arm robot to fit within the interior space of the hot cell 12. Therefore, the disclosed robot 14 and functional end effector 30 enables a single arm to perform the work traditionally performed by two (human) hands. As such, the disclosed hot cell 12 includes an autonomous robot (including autonomous simulations, algorithms, and motion planning) that is configured to fit and operate within a restrained workspace (<1 m³) for handling and conducting radiochemical research and development.

The disclosed robotic radiochemical working station can be used for a variety of different purposes, such as nuclear medicine and radiopharmaceutical research and development, pharmaceutical research development, and educational and professional training, among other uses not specifically disclosed. The disclosed robotic radiochemical working station includes many advantages over previous approaches that will be appreciated by those skilled in the art. More specifically, the disclosed robotic radiochemical working station: can be used for quick chemical reaction assessment; A compact manipulator that is capable of working in confined spaces (<1 m³); is cost effective and reduces the overall research costs compared to human labor; and uses only common supplies (no special consumable parts are required) which results in high supply chain tolerances.

In addition, the disclosed robotic radiochemical working station reduces or prevents unnecessary personnel radiation exposure in the radiochemistry working environment, improving overall safety and eliminating the traditional approach of “one synthesis per day scenario” currently used to ensure personnel safety. As seen from the above, the disclosed robotic radiochemical working station provides many advantages over previous automated radiochemical working station and analysis approaches, as will be appreciated by those skilled in the art.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

What is claimed is:

1. An automated radiochemical reaction system comprising:
a hot cell including a plurality of chemicals and components required for performing a radiochemical reaction;
a robot positioned within and coupled to an interior of the hot cell, the robot comprising a robot arm and an end effector coupled to a distal free end of the robot arm, the end effector being adapted to grasp, release, and actuate a syringe within the hot cell; and
a chemical reaction unit that includes at least one element for the radiochemical reaction to be performed;
wherein the robot is adapted to complete an automated radiochemical reaction within the hot cell without human interaction.

2. The automated radiochemical reaction system of claim 1, wherein a controller is communicatively coupled to the robot, the chemical reaction unit to send movement and operation instructions to the robot.

3. The automated radiochemical reaction system of claim 1, wherein the robot includes at least one force sensor coupled to the robot arm or the end effector, the at least one force sensor adapted to identify when the robot collides with a wall or an object within the hot cell.

4. The automated radiochemical reaction system of claim 2, wherein the robot includes at least one camera or vision system, the at least one camera or vision system being communicatively coupled to the controller.

5. The automated radiochemical reaction system of claim 1, wherein the end effector includes an actuatable and axially translatable body, and an end effector is adapted to be coupled to the syringe.

6. The automated radiochemical reaction system of claim 5, wherein the end effector further includes a first grip, a second grip, a third grip, and a fourth grip.

7. The automated radiochemical reaction system of claim 6, wherein the first grip and the second grip are adapted to be positioned on opposite sides of a plunger grip of the syringe, securely coupling the end effector to the syringe.

8. The automated radiochemical reaction system of claim 7, wherein the third grip and the fourth grip are adapted to be positioned on opposite sides of a base grip of the syringe, securely coupling the end effector to the syringe.

9. The automated radiochemical reaction system of claim 8, wherein the robot can axially translate the body of the end effector along a central axis of the body, causing the syringe to draw a liquid into the syringe or expel a liquid from the syringe.

10. The automated radiochemical reaction system of claim 5, wherein the end effector includes a generally C-shaped cross-sectional shape viewing axially along an axial direction of the body.

11. The automated radiochemical reaction system of claim 5, wherein the end effector is actuatable in a radial direction with respect to a central axis of the body.

12. The automated radiochemical reaction system of claim 1, wherein the at least one element includes a heater, compressed air cooler, magnetic stirrer, vacuum, inert gases, radiation detector for reaction monitoring, and/or ultraviolet (UV)-vis detector for chemical analysis.
